(19) United States
(12) Patent Application Publication
(10) Pub. No.: US 2025/0317828 A1
(43) Pub. Date: Oct. 9, 2025

(54) BATTERY SYSTEM AND BATTERY COMMUNICATION SYSTEM THEREOF

(71) Applicant: Grace Connection Microelectronics Limited, ZHUBEI CITY (TW)

(72) Inventors: Pei Wei Chen, Zhubei City (TW); Sheng Wei Guan, Zhubei City (TW)

(73) Assignee: Pei Wei Chen, ZHUBEI CITY (TW)

(21) Appl. No.: 19/088,914

(22) Filed: Mar. 24, 2025

(30) Foreign Application Priority Data
Apr. 3, 2024 (TW) 113112748

(51) Int. Cl. H04W 40/02; H04W 52/02

(52) U.S. Cl. CPC H04W 40/02; H04W 52/0251

(57) ABSTRACT

A battery system and a battery communication system thereof are provided. The battery communication system includes: at least one monitoring chip, at least one control unit, at least one wireless communication unit, and at least one signal flow redirection unit. The monitoring chip is connected to at least one battery unit in a plurality of battery strings. The wireless communication unit is connected to the monitoring chip, to the control unit, or connected between the monitoring chip and the control unit. The signal flow redirection unit is disposed to correspond with the wireless communication units serving as end terminals of adjacent battery strings. The wireless communication unit and the signal flow redirection unit form a signal redirecting path.

### CROSS REFERENCE

The present invention claims priority to TW113112748 filed on Mar. 3, 2025.

### BACKGROUND OF THE INVENTION

### Field of Invention

The present invention relates to an electronic system, in particular to a battery system and its battery communication system.

### Description of Related Art

For enhancing the power efficiency of battery power storage systems, the batteries applied in current industrial and automotive battery power storage systems are primarily connected in series. As the number of battery cells connected in series increases, the DC voltage across the battery series rises. However, the battery power storage systems should be able to monitor and collect the voltage and temperature information of each individual battery cell, to ensure safe operations. With the increasing DC voltage and the challenges of maintaining system safety and stability, the battery power storage system must be able to support operations under higher DC voltage without compromising their functionality.

LiFePO₄ batteries or lithium phosphate batteries, commonly used in such battery power storage systems, exhibit smoother battery discharge curves when compared to the batteries made of other materials. In other words, this characteristic necessitates more precise monitoring of battery parameters to identify any minor difference through these battery discharge curves, wherein this precise monitoring is particularly critical for managing the energy capacity of individual battery units, which can range from a few ampere-hours (2-3 Ah) to several hundred ampere-hours (200-300 Ah) during discharge. To meet this accurate monitoring necessity, the current battery power storage systems are trending toward to affiliate one monitoring chip to one battery unit.

Traditionally, when the battery units are connected in series and the battery communication system connected to the monitoring chip employs a wireless daisy chain communication path for signal transmission, the system must ensure that no signal are transmitted in the wireless daisy chain communication path, before sending the next monitoring information or command, to avoid signal collision or jamming. This requirement significantly reduces the communication efficiency of the battery communication system.

### SUMMARY OF THE INVENTION

The present invention relates to a battery system and its battery communication system, which employ a signal flow redirection unit to connect the wireless communication units, to form a signal redirecting path. This signal redirecting path can take various link shapes, such as a U-shaped signal link, an S-shaped signal link, or even a circular communication path. Once the control unit sends a command along the circular communication path (monitored by the monitoring chips) in one link direction. There is no need to wait for the last signal transmission to cease or to complete in the circular communication path, before sending the next command in the same link direction. Similarly, when one monitoring chip sends monitoring information in this link direction, other monitoring chips can also send monitoring information in the same link direction without waiting for the circular communication path to be idle. Therefore, the signal transmission efficiency of this circular communication path can be significantly higher, for example, multiple times that of the traditional signal transmission.

According to one perspective, the present invention proposes a battery communication system. The battery communication system includes at least one monitoring chip, at least one control unit, at least one wireless communication unit, and at least one signal flow redirection unit. The monitoring chip is connected to at least one battery unit within several battery strings. The wireless communication unit is connected to the monitoring chip, the control unit, or between the monitoring chip and the control unit. The signal flow redirection unit is disposed to correspond with the wireless communication units which respectively serves as end terminals of the adjacent battery strings. Together, the wireless communication units and the signal flow redirection unit form a signal redirecting path.

From another perspective, the present invention proposes a battery system. The battery system includes several battery strings, at least one monitoring chip, at least one control unit, at least one wireless communication unit, and at least one signal flow redirection unit. Each of the battery strings, includes at least one battery unit. The monitoring chip is connected to the battery unit. The wireless communication unit is connected to the monitoring chip, to the control unit, or connected between the monitoring chip and the control unit. The signal flow redirection unit is disposed to correspond with the wireless communication units which respectively serve as end terminals of the adjacent battery strings. The wireless communication units and the signal flow redirection unit can collectively form a signal redirecting path.

The objectives, technical details, features, and effects of the present invention can be better understood with regard to the detailed description of the embodiments below, with reference to the accompanying drawings.

### BRIEF DESCRIPTION OF THE DRAWINGS

FIG. 1 illustrates the battery system and its battery communication system in accordance with one embodiment of the present invention.

FIG. 2 illustrates a schematic diagram of the wireless communication unit according to one embodiment of the present invention.

FIG. 3 illustrates an enlarged 3D view of the wireless communication unit according to one embodiment of the present invention.

FIG. 4 illustrates a 3D view of the signal flow redirection unit as described in one embodiment of the present invention.

FIG. 5 illustrates a top view of the signal flow redirection unit according to one embodiment of the present invention.

FIG. 6 illustrates an enlarged 3D view of the signal flow redirection unit in accordance with one embodiment of the present invention.

### DESCRIPTION OF THE PREFERRED EMBODIMENTS

The technical terminology in this specification is based on customary understanding within the relevant art. When a term is described or defined in this specification, its interpretation should prioritize the description or the definition provided in this specification. Each embodiment of the present invention incorporates one or more technical features. To the extent possible, a person having ordinary knowledge in the art may combine or modify some or all of the technical features from any of the embodiments, to be within the scope and spirit of the present invention.

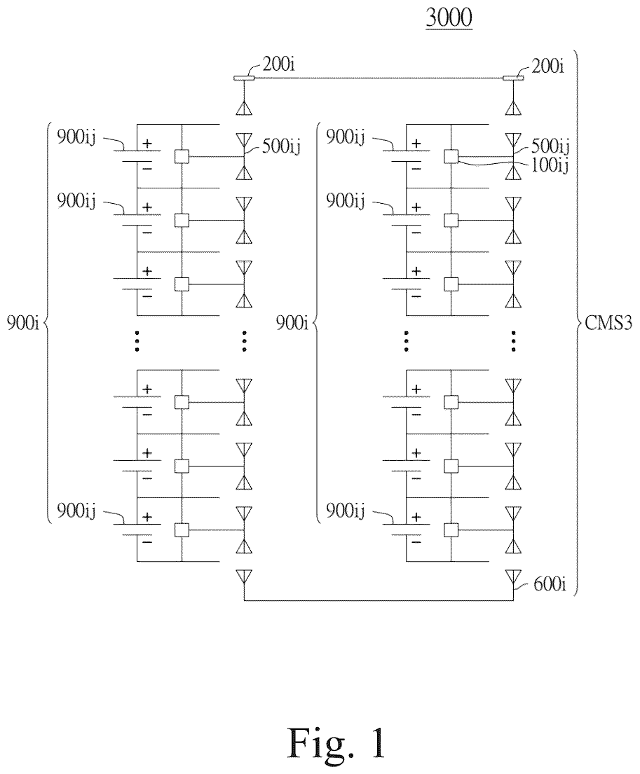

Please refer to FIG. 1, which illustrates a battery system 3000 and its battery communication system CMS3 according to one embodiment of the present invention. The battery system 3000 includes battery several strings 9001 and their corresponding battery communication systems CMS3. The battery string 900i includes several battery units 900ij, which may, in some embodiments, include only one battery unit 900ij. The battery unit 900ij can be, for example, a lithium-phosphate battery or a ternary lithium battery. The battery units 900ij can be connected in series, to form at least one battery string 900i. In one embodiment, each of the battery strings 900i can be connected in parallel, or further in series to form a U-shaped signal link or an S-shaped signal link. For example, two battery strings 900i can be serially connected to form the U-shaped signal link. Three or more battery strings can be serially connected in the S-shaped signal link.

When operating the battery system 3000, it is essential to monitor the battery units 900ij to ensure that the temperature, the voltage and other battery parameters of the operating battery units 900ij are normal. Especially when the battery units 900ij are the lithium phosphate batteries, which have a relatively smooth battery discharge curve. For precise monitoring, each battery unit 900ij requires a dedicated monitoring chip 100ij.

As shown in FIG. 1, the battery communication system CMS3 includes the monitoring chips 100ij, at least one control unit 200i, several wireless communication units 500ij, and at least one signal flow redirection unit 600i. In one embodiment, if necessary, the system can include only one monitoring chip 100ij, only one control unit 200i, only one wireless communication unit 500ij, and only one signal flow redirection unit 600i. The one monitoring chip 100ij is connected to the one battery unit 900ij. The monitoring chips 100ij are one-on-one connected to the battery units 900ij. The count number of the wireless communication units 500ij can be the same as the count number of the monitoring chips 100ij.

The control unit 200i can be used to control these monitoring chips 100ij and to collect monitoring information from the monitoring chips 100ij. The wireless communication unit 500ij is connected to the monitoring chip 100ij, to the control unit 200i, or between the monitoring chip 100ij and the control unit 200i. In one battery string 900i as shown in FIG. 1, the control unit 200i, the monitoring chips 100ij (from the first to the last), are interconnected with a wireless whisper communication formed between the wireless communication units 500ij. The wireless whisper communication formed between the wireless communication units 500ij in each of the battery strings 900i, can correspondingly form a wireless daisy chain communication path.

The signal flow redirection unit 600i can be disposed between the wireless communication units 500ij which respectively serve as each end terminal of the two adjacent battery strings 900i (or, at least one end terminal of the two adjacent battery strings 900i). The signal flow redirection unit 600i can facilitate the wireless whisper communication with the wireless communication units 500ij. These wireless communication units 500ij and the signal flow redirection unit 600i form a signal redirecting path; for example, they can form a circular communication path. In other words, the wireless daisy chain communication path connecting these battery strings 900i, can incorporate the signal redirecting path through the integration of the signal flow redirection unit 600i. The end wireless communication unit 500ij and the signal flow redirection unit 600i can form a signal redirecting path in the same circuit board.

The wireless whisper communication between the wireless communication unit 500ij and at least one signal flow redirection unit 600i, is effective only between the adjacent wireless communication units 500ij, or between the signal flow redirection unit 600i and its adjacent wireless communication unit 500ij. The above-mentioned wireless whisper communication can be established without other interference from other non-adjacent wireless communication units 500ij or other non-adjacent signal flow redirection units 600i. Meanwhile, this wireless whisper communication is protected from the interference by other wireless communication units 500ij and other signal flow redirection units 600i.

The controller 200i can include, for example, a circuit, a circuit board, a program code storage device, or a chip. The chip can include, but is not limited to: a central processing unit (CPU), a general-purpose or special-purpose programmable micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable logic device (FPLD), other similar components, or combinations of the aforementioned components.

In one embodiment, the control unit 200i can be time calibrated via a master computer or a master server, to ensure that the control unit 200i operates according to standardized time information. The control unit 200i can transmit a time calibration signal to the monitoring chips 100ij through the wireless communication units 500ij and the signal flow redirection unit 600i. The monitoring chips 100ij can then synchronize their internal circuit time according to the time calibration signal.

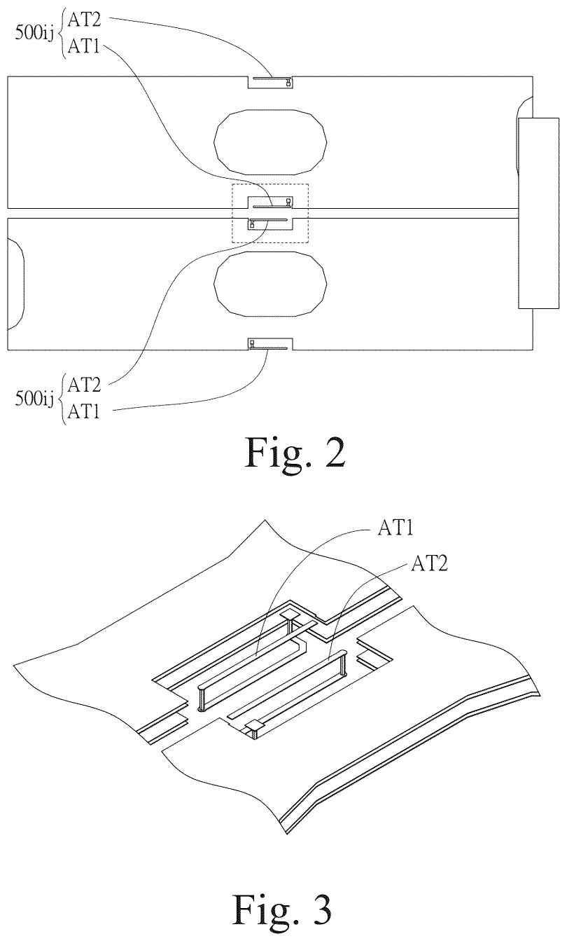

In one embodiment, the wireless communication unit 500ij can be an antenna module, for example. Please refer to FIGS. 2 and 3, wherein FIG. 2 illustrates a schematic diagram of the wireless communication unit 500ij according to one embodiment of the present invention, and FIG. 3 illustrates a three-dimensional enlarged view of the wireless communication unit 500ij according to one embodiment of the present invention. Each of the wireless communication units 500ij includes a first antenna AT1 and a second antenna AT2. The first antenna AT1 and the second antenna AT2 are connected to one of the monitoring chips 100ij.

The first antenna AT1 and the second antenna AT2 both connected to the same adjacent monitoring chip 100ij, are not directly connected to each other by physical conductive means, but able to communicate via wireless signals. The air medium between the first antenna AT1 and the second antenna AT2, can withstand the high cross-voltage generated by the battery units 900ij in series connection, to enhance operational safety.

In one embodiment, the first antenna AT1 of one wireless communication units 500ij and the second antenna AT2 of previous wireless communication units 500ij are not connected to the same adjacent monitoring chip 100ij, may be connected to the same physical conductive means, but does not able to communicate via wireless signals, as shown in FIG. 2. Or, the second antenna AT2 of one wireless communication units 500ij and the first antenna AT1 of next wireless communication units 500ij not connected to the same adjacent monitoring chip 100ij, may be connected to the same physical conductive means, but does not able to communicate via wireless signals, as shown in FIG. 2.

As shown in FIG. 1, the signal flow redirection unit 600i is employed to connect a series connection of wireless communication units 500ij in a U-shaped signal link or an S-shaped signal link, to form the signal redirecting path for the wireless whisper communication. The signal flow redirection unit 600i and the wireless communication unit 500ij can function as antenna modules; however, the signal flow redirection unit 600i has a different circuit structure from that of the wireless communication unit 500ij.

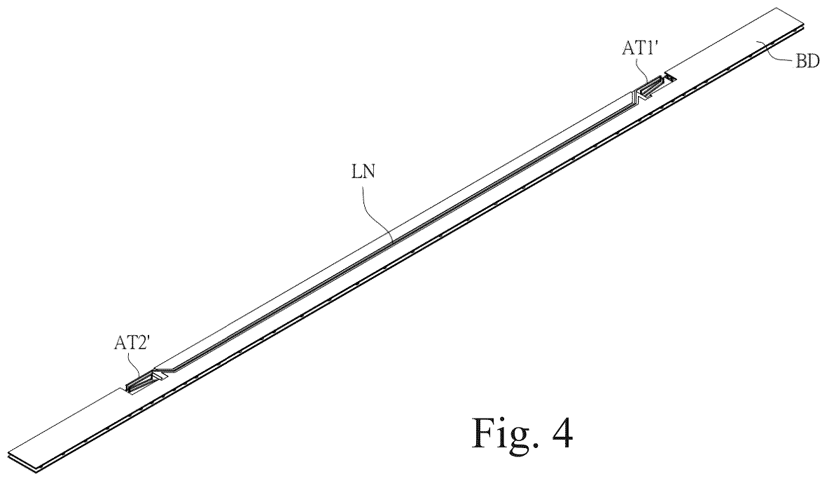

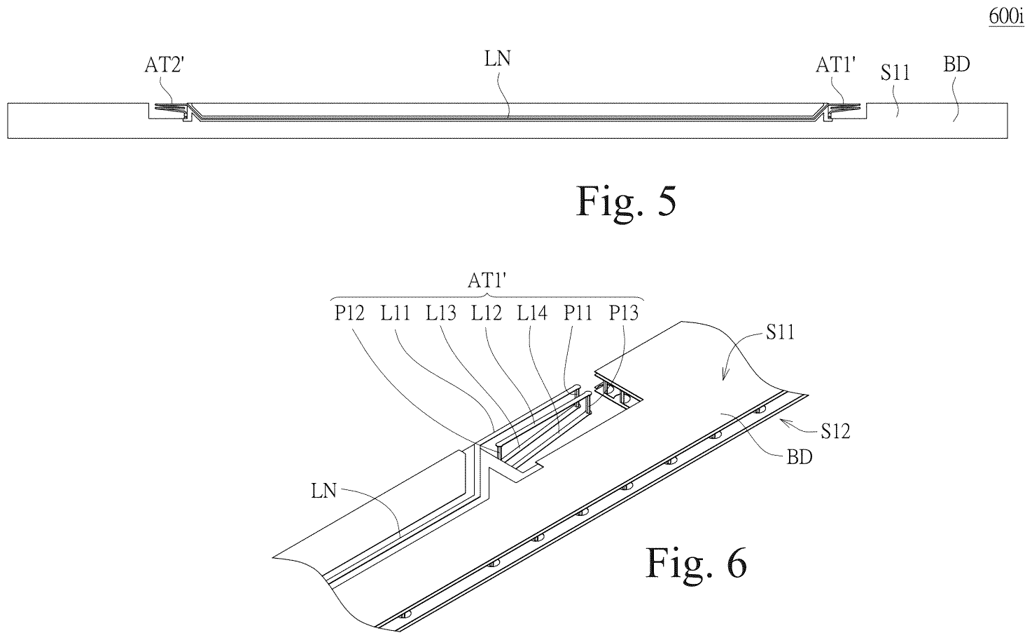

Please refer to FIGS. 4 to 6: FIG. 4 illustrates a 3D view of the signal flow redirection unit 600i based on one embodiment of the present invention, FIG. 5 illustrates a top view of the signal flow redirection unit 600i based on one embodiment of the present invention, and FIG. 6 illustrates an enlarged view of the signal flow redirection unit 600i based on one embodiment of the present invention. The signal flow redirection unit 600i includes a circuit board BD, a first antenna AT1′, a second antenna AT2′, and a signal-redirecting circuit LN. The first antenna AT1', the second antenna AT2′ and the signal-redirecting circuit LN are disposed on the circuit board BD. The signal-redirecting circuit LN is connected to first antenna AT1′ and the second antenna AT2′.

As shown in FIGS. 4 and 5, the first antenna AT1′ and the second antenna AT2′ of the signal flow redirection unit 600ij, are disposed on the same side of the circuit board BD. This arrangement facilitates wireless whisper communication with the wireless communication units 500ij, which are likewise disposed to the same side of the circuit board BD.

In one embodiment, the dimensions or scales of corresponding structures of the first antenna AT1′ and the second antenna AT2′ in the signal flow redirection unit 600i, are substantially identical. The first antenna AT1′ and the second antenna AT2′ in the signal flow redirection unit 600i, both radiate at the same frequency and operate without any signal interference under the low radiation strength of the whisper wireless communication.

As shown in FIG. 6, the first antenna AT1′ includes a first metal wire L11, a second metal wire L12, a third metal wire L13, a fourth metal wire L14, a first conduction pillar P11, a second conduction pillar P12, and a third conduction pillar L13. The dispositions of the first metal wire L11 and the second metal wire L12, are substantially parallel to each other on a first surface S11 of the circuit board BD. The dispositions of the third metal wire L13 and the fourth metal wire L14 are substantially parallel to each other on a second surface S12 of the circuit board BD. The conduction pillars penetrate the circuit board BD and establish electrical connections as follows: the first conduction pillar P11 penetrates the circuit board BD and connects the first metal wire L11 and the third metal wire L13; the second conduction pillar P12 penetrates the circuit board BD and connects the second metal wire L12 and the third metal wire L13; and the third conduction pillar P13 penetrates the circuit board BD and connects the second metal wire L12 and the fourth metal wire L14.

In one embodiment, the structure of the second antenna AT2′ can be substantially the same as that of the first antenna AT1′, and the detail of the second antenna AT2′ is not repeatedly elaborated herein.

As shown in FIG. 5, the signal-redirecting circuit LN is disposed on the first surface S11 of the circuit board BD, aligned with the two slope edges and one parallel side of a trapezoid layout.

Through the signal flow redirection unit 600i, the series connection of the wireless communication units 500ij can form a circular communication path in the U-shaped signal link or the S-shaped signal link, wherein the control unit 200i can send a command to the monitoring chip 100ij in one link direction of the circular communication path and continue sending commands in the same link direction without waiting for signal transmission to cease. Similarly, after one monitoring chip 100ij sends monitoring information in this link direction, other monitoring chips 100ij can continue to send their monitoring information consecutively in this link direction without delays caused by signal interference. This continuous signal transmission enables the circular communication path to achieve near-unlimited transmission efficiency.

In one embodiment, the wireless communication unit, or the signal flow redirection unit, can be implemented as a radio frequency coupler including a circuit board and two communication wires.

Alternatively, the wireless communication unit, or the signal flow redirection unit, can be implemented as an optical transceiver which includes a light-receiving unit and a light-emitting unit.

According to the above embodiment, the signal flow redirection unit 600i connects a series of the wireless communication units 500ij to form the circular communication path within the U-shaped signal link or the S-shaped signal link. The control unit 200ij can send commands to the monitoring chip 100ij in one link direction of the circular communication path without waiting for signal transmission to cease before sending subsequent commands. Similarly, the monitoring chips 100ij can transmit their monitoring information sequentially in the same link direction without delays. This configuration allows the circular communication path to achieve near-unlimited transmission efficiency.

The terms “connection”, “connect”, “connected”, and “connecting” as described in the above description, respectively refer to “electrical connection”, “electrically connect”, “electrically connected”, and “electrically connecting”, wherein the terms “electrical” and “electrically” are intended to encompass both wired conductive connections and wireless signal-based connections.

The above description discloses various features through several embodiments and/or examples for implementing the present invention. The components and configurations described above are intended to simplify/illustrate the implementations of the present invention for illustrative purposes only. These descriptions are not intended to limit the scope of the present invention. Further, repeated reference symbols or markings may appear in some embodiments for simplification and clarification purposes. Such repetition imply does not any specific relationship between the described embodiments or configurations.

The present invention has been disclosed through the embodiments, which are not intended to limit its scope. Those skilled in the art may make modifications or enhancements without departing from the scope of the invention. Therefore, the scope of the present invention is defined by the claims provided herein.

What is claimed is:

1. A battery communication system, including:
at least one monitoring chip, connected to at least one battery unit in a plurality of battery strings;
at least one control unit;
at least one wireless communication unit, connected to the at least one monitoring chip, to the at least one control unit, or between the at least one monitoring chip and the at least one control unit; and
at least one signal flow redirection unit, disposed to correspond with the at least one wireless communication unit serving as at least one end terminal of the adjacent battery strings, the at least one wireless communication unit and the signal flow redirection unit forming a signal redirecting path.

2. The battery communication system according to claim 1, wherein
a count number of the at least one battery unit is plural, a count number of the at least one monitoring chip is plural, wherein each of the monitoring chips is connected to one of the battery units in the battery strings;
a count number of the at least one wireless communication unit is plural, wherein each of the wireless communication units is connected to one of the monitoring chips, to the at least one control unit, or between the at least one control unit and one of the monitoring chips; and
the at least one signal flow redirection unit, disposed between the wireless communication units serving as the end terminals of the adjacent battery strings, the wireless communication units and the at least one signal flow redirection unit forming the signal redirecting path.

3. The battery communication system according to claim 2, wherein each of the wireless communication units is an antenna module.

4. The battery communication system according to claim 3, wherein each of the wireless communication units, includes:
a first antenna; and
a second antenna, wherein the first antenna and the second antenna are connected to one of the monitoring chips.

5. The battery communication system according to claim 2, wherein each of the signal flow redirection units, includes:
a circuit board;
a first antenna, disposed on the circuit board;
a second antenna, disposed on the circuit board; and
a signal-redirecting circuit, disposed on the circuit board, wherein the signal-redirecting circuit is connected to the first antenna and the second antenna, separately.

6. The battery communication system according to claim 5, wherein the first antenna and the second antenna of the same signal flow redirection unit, disposed on the same side of the circuit board.

7. The battery communication system according to claim 5, wherein the corresponding structure dimensions of the first antenna and the second antenna of the same signal flow redirection unit, are substantially identical.

8. The battery communication system according to claim 5, wherein the corresponding structures of the first antenna and the second antenna of the same signal flow redirection unit, are substantially identical.

9. The battery communication system according to claim 2, wherein the wireless communication units and the at least one signal flow redirection unit are antenna modules, wherein the structures of the wireless communication units are different from the structures of the signal flow redirection unit.

10. The battery communication system according to claim 2, wherein the wireless communication units include a plurality of radio frequency couplers.

11. The battery communication system according to claim 2, wherein each of the wireless communication units is an optical transceiver.

12. A battery system, including:
a plurality of battery strings, each of the battery strings including at least one battery unit;
at least one monitoring chip, connected to the at least one battery unit;
at least one control unit;
at least one wireless communication unit, connected to the
at least one monitoring chip, to the at least one control unit, or between the at least one monitoring chip and the at least one control unit; and
at least one signal flow redirection unit, disposed to correspond with the wireless communication units serving as end terminals of the adjacent battery strings, wherein the at least one wireless communication unit and the signal flow redirection unit form a signal redirecting path.

13. The battery system according to claim 12, wherein
a count number of the at least one battery unit is plural, a count number of the at least one monitoring chip is plural, wherein each of the monitoring chips is connected to one of the battery units in the battery strings;
a count number of the at least one wireless communication unit is plural, wherein each of the wireless communication units is connected to one of the monitoring chips, to the at least one control unit, or between the at least one control unit and one of the monitoring chips; and
the at least one signal flow redirection unit, disposed between the wireless communication units serving as the end terminals of the adjacent battery strings, wherein the wireless communication units and the at least one signal flow redirection unit form the signal redirecting path.

14. The battery system according to claim 13, wherein each of the wireless communication units is an antenna module.

15. The battery system according to claim 14, wherein each of the wireless communication units, includes:
a first antenna; and
a second antenna, wherein the first antenna and the second antenna are connected to one of the monitoring chips.

16. The battery system according to claim 13, wherein each of the signal flow redirection units, includes:
a circuit board;
a first antenna, disposed on the circuit board;
a second antenna, disposed on the circuit board; and
a signal-redirecting circuit, disposed on the circuit board, wherein the signal-redirecting circuit is connected to the first antenna and the second antenna, separately.

17. The battery system according to claim 16, wherein the first antenna and the second antenna of the same signal flow redirection unit, are disposed on the same side of the circuit board.

18. The battery system according to claim 16, wherein the corresponding structure dimensions of the first antenna and the second antenna of the same signal flow redirection unit, are substantially identical.

19. The battery system according to claim 16, wherein the corresponding structures of the first antenna and the second antenna of the same signal flow redirection unit, are substantially identical.

20. The battery system according to claim 13, wherein the at least one wireless communication unit and the at least one signal flow redirection unit are antenna modules, wherein the structures of the wireless communication unit are different from that of the signal flow redirection unit.

21. The battery system according to claim 13, wherein the wireless communication units include a plurality of radio frequency couplers.

22. The battery system according to claim 13, wherein the at least one wireless communication unit is an optical transceiver.
